(19) United States
(12) Patent Application Publication
(10) Pub. No.: US 2008/0010111 A1
(43) Pub. Date: Jan. 10, 2008

(54) MANAGING SYSTEM AND PORTABLE TERMINAL DEVICE

(75) Inventor: Atsunori Suto, Inagi (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/846,767

(22) Filed: Aug. 29, 2007

Related U.S. Application Data
(63) Continuation of application No. PCT/JP2005/003930, filed on Mar. 8, 2005.

(51) Int. Cl. H04M 3/51

(52) U.S. Cl. 705/11

(57) ABSTRACT

The present invention is constructed to comprise a second storage unit which can store second progress state information that is formed by registering work progress information indicating work progress performed to the plurality of work subjects in association with each work subject; a reading unit which can read the first progress state information stored in said first storage unit of said electronic tag; a comparing unit which compares the second progress state information stored in said second storage unit and the first progress state information read by said reading unit; and an updating unit which updates the first progress state information and the second progress state information based on the comparison result obtained by the comparison unit. As a result, when multiple operators perform work to multiple work subject, operators can perform work efficiently, and an occurrence of multiplex work can also be prevented.

### TECHNICAL FIELD

The present invention relates to a technique for managing the progress state of work in which operators performs multiple work subjects, such as an inventory work to stock items.

### BACKGROUND ART

So far, for example, when an inventory of stock products in a store is taken by multiple operators, the objects of the inventory are divided into multiple work subjects (for example, each shelf), and these multiple shelves are assigned to each operator. These operators perform an inventory work to the work subject assigned to them.

In such an inventory work, time taken for an inventory work to the shelves depends on operators, and thus, some operators can complete the inventory work to the assigned shelf to them in short time.

Such an operator who has completed the inventory work assigned to him/her also perform an inventory work to shelves assigned to other operators in order to make the inventory in the store completed early. In such a case, the operator moves to a shelve that is assigned to another operator, and evaluates whether or not an inventory work to the shelf has been completed. If an inventory work has not yet been performed, the operator starts an inventory work. On the other hand, if an inventory work to the shelf has been completed, or if another operator is being taking an inventory of the shelf, the operator moves to the next shelf, and evaluates whether or not an inventory work has been completed to that next shelf.

In this manner, operators' moving around in a store to look for shelves to which an inventory work has not yet been done is inefficient, and it is an issue that operators' spare time cannot be efficiently used.

Further, it is considerable that each operator reports the completion of an inventory work every when an inventory work to each shelf is completed, and a server computer or the like is used to manage the progress state of an inventory work of each operator in real time, and reports to an operator a shelf to which an inventory work is to be performed. In this case, however, cost occurs for the management and operation, etc., of the server computer, so that it is not economical.

In addition, when multiple operators perform an inventory work, these multiple operators perform an inventory work to the same shelf in duplicate, so that a multiplex inventory can occur.

Further, for example, in the following patent document 1 and patent document 2, product management tags are attached to the products which are objects of an inventory, and product information is communicated by electric wave inducement communication, thereby performing an inventory work automatically. However, in techniques disclosed in patent document 1 and patent document 2, establishing and installing of a reading device for reading product management tags requires significant effort and cost.

With the foregoing problems in view, one object of the present invention is to make it possible, when multiple operators perform work to multiple work subjects, for the operators to perform work efficiently. Another object of the invention is to prevent an occurrence of multiplex work.

Patent Document 1: Japanese Patent application Laid-open No. HEI 8-101980

Patent Document 2: Japanese Patent application Laid-open No. HEI 10-338312

### DISCLOSURE OF THE INVENTION

In order to accomplish the above object, according to the present invention, there is provided a management system which manages the progress of work performed to a plurality of work subjects, which work is performed by one or more operators, the system comprising: an electronic tag provided for each of the work subjects; and a portable terminal device which can be carried by the operator, and communicable with the electronic tag, wherein the electronic tag includes: a first storage unit which can store first progress state information that is formed by registering work progress information indicating work progress performed to the plurality of work subjects in association with each work subject, and wherein the portable terminal device includes: a second storage unit which can store second progress state information that is formed by registering work progress information indicating work progress performed to the plurality of work subjects in association with each work subject; a reading unit which can read the first progress state information stored in the first storage unit of the electronic tag; a comparing unit which compares the second progress state information stored in the second storage unit and the first progress state information read by the reading unit; and an updating unit which updates the first progress state information and the second progress state information based on the comparison result obtained by the comparison unit.

As a preferred feature, the updating unit includes. a first updating unit which updates the first progress state information by registering the progress state information registered only in the second progress state information to the first progress state information; and a second updating unit which updates the second progress state information by registering the progress state information registered only in the first updating state information to the second progress state information.

As another preferred feature, the portable terminal device includes an input unit to which a work complete report, which indicates that the work to the work subject by the operator is completed, is input; the first updating unit updates the first progress state information of the first storage unit based on the work complete report input by the input unit, and the second updating unit updates the second progress state information of the second storage unit based on the work complete report input by the input unit.

As yet another preferred feature, the portable terminal device includes a progress state registering unit which is capable of registering the progress state information indicating “work in-progress” to the first progress state information in the first storage unit to the work subject relating to the electronic tag. In addition, the portable terminal can include a work processing unit which performs processing relating to the work. Further, the portable terminal can include a work information storage unit which can store information used in the work.

As a generic feature, there is provided a portable terminal device, which can be carried by an operator who performs work to a plurality of work subjects, which portable terminal device is communicable with an electronic tags which are provided for the plurality of work subjects, and which has a first storage unit that can store the first progress state information formed by the progress state information indicating the progress state of work which is performed to the plurality of work subjects in association with each work subject, wherein the portable terminal device includes: a second storage unit which is capable of storing second progress state information formed by registering the progress state information indicating the progress state of the work performed to the plurality of work subject in association with each work subject; a reading unit which is capable of reading the first progress state information stored in the first storage unit of the electric tag; a comparing unit which compares the second progress state information stored in the second storage unit with the first progress state information read by the reading unit; and an updating unit which updates the first progress state information and the second progress state information based on the comparison result by the comparison unit.

As a preferred feature, the updating unit includes: a first updating unit which updates the first progress state information by registering the progress state information, which is registered only in the second progress state information, to the first progress state information; and the second updating unit which updates the second progress state information by registering the progress state information registered only in the first progress states information to the second progress state information.

As another preferred feature, a portable terminal device comprises: an input unit to which the work complete report is input which indicates that the work to the work subject is completed, wherein the first update unit updates the first progress state information of the first storage unit based on the work complete report input by the input unit, and wherein the second updating unit updates the second progress state information stored in the second storage unit based on the work completion report input by the input unit.

As yet another preferred feature, a portable terminal device comprises a progress state registering unit which is capable of registering the progress state information indicating “work in-progress' to the first progress state information in the first storage unit to the work subject relating the electronic tag. In addition, a portable terminal device can further comprise a work processing unit which performs processing relating to the work. Further, a portable terminal device further comprises a work information storage unit which is capable of storing information used in the work.

The present invention guarantees the following effects and benefits.

(1) It is possible to know the progress state in the work subject on the bases of the updated first progress state information, so that a work can be efficiently performed.

(2) It is possible to prevent an occurrence of multiplex work to a work subject.

(3) Since it is not necessary to manage the progress state using a server computer, work management can be performed in low cost.

### BRIEF DESCRIPTION OF THE DRAWINGS

FIG. 1 is a diagram schematically showing a construction of an inventory system (management system) according to one preferred embodiment of the present invention;

FIG. 2 is a diagram schematically showing an example of arrangement of shelves to be subjected to work of the inventory system and IC tags (electronic tags) set to each shelf;

FIG. 3 is a diagram showing an example of a first progress state information stored in an IC tag memory in the inventory system according to one preferred embodiment of the present invention;

FIG. 4 is a flowchart for describing an operator's operation process in the inventory system according to one preferred embodiment of the present invention.

FIG. 5(a) and FIG. 5(b) are diagrams showing an state example of a first progress state information and a second progress state information in the inventory system according to one preferred embodiment of the present invention;

FIG. 6(a), FIG. 6(b), FIG. 6(c), and FIG. 6(d) are diagrams schematically showing the progress state of work when the inventory work is performed using the inventory system according to one preferred embodiment of the present invention.

### BEST MODE FOR CARRYING OUT THE INVENTION

An embodiment of the present invention will now be described with reference to the relevant accompanying drawings.

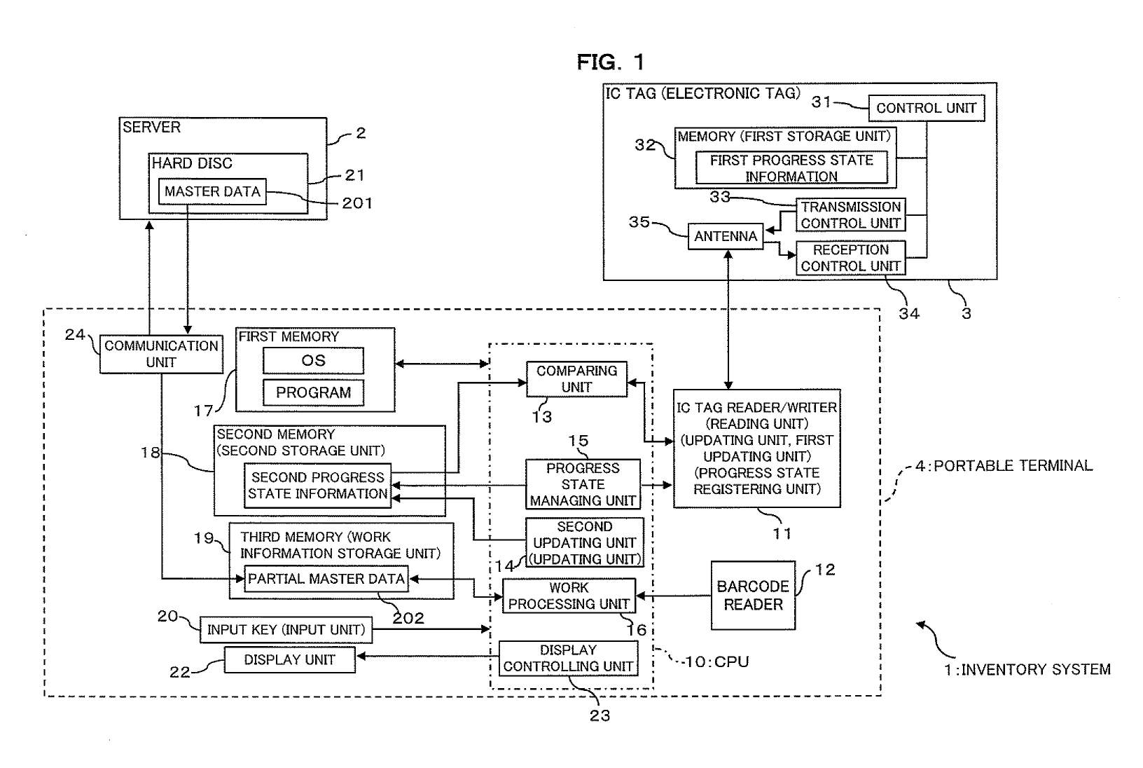

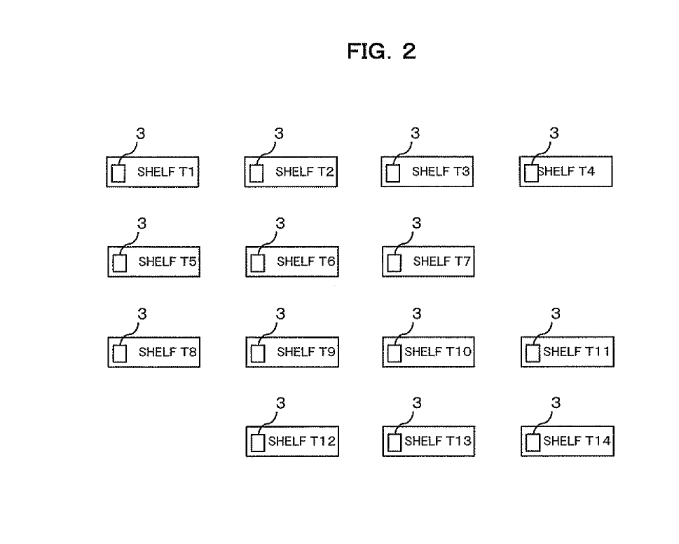

FIG. 1 is a diagram schematically showing a construction of an inventory system (managing system) according to one preferred embodiment of the present invention; FIG. 2 is a diagram schematically showing shelves subjected to the work and arrangement example of an IC tag (electronic tag) set to each shelf.

The present inventory system 1 is a system for an inventory work of stock products stored in multiple (in the present embodiment, 14) shelves (work subjects) installed in a store as shown in FIG. 2, by multiple operators (in the present example, four).

Further, in the present embodiment, each shelf is indicated by the combination of the reference character T and number (in the present embodiment, integers from 1 through 14; shelf number), that is, reference characters T1 through T14.

As shown in FIG. 1, the present shelf system 1 includes a server 2, a portable terminal 4, and an IC tag 3.

The server 2 is realized, for example, by a computer having a server function and a hard disc 21, to which master data 201 used in inventory is stored. The master data 201 is data for performing inventory work, and for example, is constructed by the products to be left in each shelf as stocks and the number of stocks.

Further, the server 2 is communicable with multiple portable terminals 4, which will be detailed later. The server 2, divides (or copies) only parts corresponding to the predetermined shelf to create partial master data 202 based on the partial master data transmission request performed by each portable terminal 4, and transmits the partial master data 202 to the portable terminal 4. In this instance, according to the present embodiment, the server 2 and the portable terminal 4 are communicable by radio.

An IC tag (electronic tag) 3 is an area tag attached to predetermined work region (in the present embodiment, each shelf) beforehand, for performing inventory work in order to instructing a work area of the inventory work. As shown in FIG. 1, the IC tag 3 includes: a control unit 31; a memory 32; a transmission control unit 33; a receiver control unit 34; and an antenna 35.

The memory (first storage unit) 32 is a non-volatile memory such as flash memory. The IC tag reader/writer 11 of the portable terminal 4 can write (store) various information and read the information having been already recorded, and the IC tag reader/writer 11 is capable of rewriting of information of the storage information.

The memory 32 stores first progress state information formed by registering the progress state information (flag) indicating the progress state of inventory work of each shelf corresponding to each work subject.

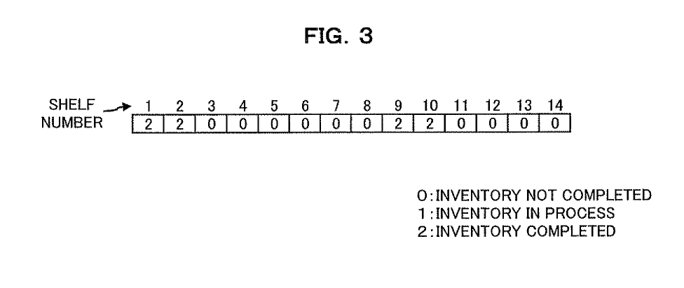

FIG. 3 is a diagram showing an example of the first progress state information stored in the memory 32 of the IC tag 3 of the inventory system according to one preferred embodiment of the present invention. As shown in FIG. 3, the first progress state information is associated with the shelf number of each shelf, and registers in any one of “0”, “1”, and “2” as the progress state information.

Here, the progress state information “0” indicates a shelf is not yet subjected to inventory (inventory not completed); the progress state information “1” indicates a shelf is being now subjected to inventory (inventory in progress); the progress state information “2” indicates the inventory of a shelf is completed (inventory completed).

This first progress state information is constructed so as to store “0” at its initial state. When operators input, with the portable terminal 4, the inventory state that inventory is in-progress or that inventory is completed in accordance with the progress state of the work, the progress state information “1” and “2” is stored in association with the corresponding shelf (shelf number).

That is, the memory 32 functions as a first storage unit which can store the first progress state information that is formed by registering the progress state information indicating the progress state of the work (inventory work) performed to multiple work subjects (shelves T1 through T14 according to the present embodiment) in association with each shelf.

Antenna 35 receives and transmits an electric wave, and is formed in a coil shape, for example, and installed in the IC tag 3. Further, antenna 35 receives an electric wave of electric wave inductive communication sent from the IC tag reader/writer 11 of the portable terminal 4, thereby exciting electric current, and supplies electric current necessary for driving each parts (control unit 31, memory 32, transmission control unit 33, and reception control unit 34).

The transmission control unit 33 and the reception unit 34 perform control for data reception and transmission with a portable terminal 4 (IC tag reader/writer 11) through the antenna 35. The transmission control unit 33 controls for transmitting varying data and command, etc., outside IC tag 3 (portable terminal 4) through the antenna 35, and sends the first progress state information stored in the memory 32 to the IC tag reader/writer 11. The reception control unit 34 performs control for receiving varying data and commands through antenna 35. For example, it receives the progress state information sent from the IC tag reader/writer 11, and the second progress state information, or the like.

Then, the IC tag 3 is communicable with the IC tag reader/writer 11 of the portable terminal 4, described later, through the transmission control unit 33, the reception controlling unit 34, and the antenna 35.

The control unit 31 performs operation control of the memory 32, the transmission control unit 33, and the reception controlling unit 34. In the present embodiment, the CPU (Central Processing Unit; not illustrated) executes a program stored in the memory 32 beforehand, thereby realizing functions of the control unit 31, the transmission control unit 33, and the reception controlling unit 34.

Further, the present inventory system 1, an LSI (Large Scale Integration) having functions of a control unit 31, the memory 32, the transmission control unit 33, and the reception controlling unit 34 is given.

The portable terminal 4 is an information processing device which can be carried by operators who perform inventory work. The portable terminal 4, as shown in FIG. 1, includes: a CPU 10 [a comparing unit 13, a second updating unit (updating unit) 14; a progress state managing unit 15, a work processing unit 16; a display control unit 23]; an IC tag reader/writer (a reading unit, an updating unit, a first updating unit, a progress state registering unit) 11; a barcode reader 12; a first memory 17; a second memory (second storing unit) 18; a third memory (work information storing unit) 19; and an input key (input unit) 20; a display unit 22; and a communication unit 24.

The communication unit 24 performs communication with the server 2. Under instructions of the CPU 10, the communication unit 24 sends a request signal of the mater data 201, and receives a part of the master data 201 sent from the server 2. In this instance, the partial master data 202 received from the server 2 is stored in the third memory 19.

The first memory 17 stores an OS and programs for making the portable terminal 4 operate. For example, it is constructed by a ROM (Read Only Memory) and a RAM (Random Access Memory).

The third memory 19 is a non-volatile memory such as a flash memory. It records (stores) varying information and reads already recorded information under control of the CPU 10. The third memory 19 functions as work information storing unit for storing the partial master data 202 downloaded from the server 2, and for storing information used in inventory work.

The second memory 18 is a non-volatile memory such as a flash memory, etc. It records (stores) varying information and reads already recorded information under control of the CPU 10. The second memory 18 stores the second progress state information which is formed by registering the progress state information (flag) indicating the progress state of inventory work of each shelf in association with each work. This second progress information is constructed in the similar manner to the first progress state information (see FIG. 3) stored in the memory 32 of the IC tag 3, and any one of the numbers of “0”, “1”, and “2” is registered as the progress state information in association with the shelf number of each shelf.

That is, the second memory 18 functions as the second storing unit which can store the second progress state information which is formed by registering the progress state information indicating the progress state of work (inventory work) performed to multiple work subjects (in the present embodiment, the shelf T1 through T14) in association with each shelf.

In addition, like the first progress state information, as to the progress state information of the second progress state information, “0” is stored at the initialized state. By means of performing inputting operation, with the portable terminal 4, that inventory work is in-progress or completed, the progress state information “1” or “2” is stored in association with the corresponding shelf (shelf number).

The IC tag reader/writer (reading unit, updating unit, first updating unit, progress state registering unit) 11 reads data from the memory 32 of the IC tag 3, and writes data to this memory under control of the CPU 10.

An operator brings the IC tag reader/writer 11 of the portable terminal 4 near to the IC tag 3, and performs the predetermined input operation with the input keys 20 or the like, thereby accessing the memory 32 of the IC tag 3 from the portable terminal 4 via the IC tag reader/writer 11. As a result, it is possible to communicate varying data with the memory 32, such as read and update of the first progress state information.

The IC tag reader/writer 11 functions as a reading unit which is capable of reading the first progress state information stored in the memory 32 of the IC tag 3, and also, it functions as an update unit which updates the memory 32 of the IC tag 3 based on the comparison result of the comparing unit 13 described later.

More precisely, as to the shelf number to which are registered the progress state information “1” and “2” only in the second progress state information and to which is registered the progress state “0” in the first progress state information, to the shelf number in the first progress state information the progress state information “1” or “2” is registered based on the second progress state information. In this manner, the first progress state information is updated. That is, the IC tag reader/writer 11 registers the progress state information “1” and “2” registered in the second progress state information to the first progress state information, thereby updating this first progress state information.

Further, this IC tag reader/writer 11 functions as a progress state registering unit which registers the progress state of the inventory work to the shelf to which an IC tag 3 is attached, to the first progress state information in the memory 32 of the IC tag 3 under the instruction of the progress state managing unit 15 as described later.

For example, before an operator begins taking inventory of a shelf r the operator inputs that an inventory operation is started (inventory in progress) with the input key 20 of the portable terminal 4. After that, using the IC tag reader/writer 11 of the portable terminal 4, to the first progress state information stored in the memory 32 of the IC tag 3, the progress state information “1” is registered in correspondence with the shelf number of the shelf attached with the IC tag 3.

When the operator completes the inventory work to the shelf, the operator inputs that the inventory work is completed (inventory completed) through input key 20 of the portable terminal 4. After that, using the IC tag reader/writer 11 of the portable terminal 4, the operator registers the progress state information “2” corresponding to the shelf number of the shelf to which an IC tag 3 is attached to the first progress state information stored in the memory 32 of the IC tag 3.

The barcode reader 12 is a reading device which can read a barcode (product information) formed on the subject to inventory beforehand. For example, a barcode attached to a product is detected with an optical sensor, and the bar pattern and the predetermined character bar pattern are compared, and converted into character data, thereby reading a bar code.

In this instance, the present inventory system 1 should not be limited in the types of bar codes, or its specifications, or the reading method. For example, varying bar codes such as EAN, JAN, CODE39, ITF, NW-7, CODE128, CODE93, etc., and a two-dimensional bar code, a three-dimensional barcode, a book code, a magazine code, etc. can be used.

The display unit 22 is constructed by an LCD (Liquid Crystal Display), for example, and it presents varying information to operators under control of the display control unit 23. For example, the display unit 22 is capable of presenting data such as the first progress state information, the second progress state information, the partial master data 202, information input though the input key, and instructions and messages from a program.

The input key 20 is used by an operator of the portable terminal 4 to input varying information and instructions. For example, it is constructed as a touch display including functions of a key board, a touch-panel, a display unit 22.

In the present inventory system 1, when an operator begins to take inventory of a certain shelf, the operator uses an input key 20 to input that the inventory of the shelf is in progress. Hereby, the progress state information “1” is registered by the progress state management unit 15 to the second progress state information, and by IC tag reader/writer 11 to the first progress state information of the memory 32 of the IC tag 3.

Further, in the present inventory system 1, before starting inventory work, an operator uses the input key 20 to input instruction that the partial master data 202 relating to the shelf is obtained. Upon this instruction, the CPU 10 transmits the partial master data transmission request to the server 2 through communication unit 24, and further, the partial master data 202 created and transmitted by the server 2 is received by the communication unit 24 and stored in the third memory 19.

Still further, during the inventory operation, this input key 20 is used to input the number of goods in stock, and the input information is notified to the work processing unit 16.

Furthermore, in the inventory system 1, when an inventory work is completed to a certain shelf, the completion of the inventory work is input through the input key 20. With this arrangement, the progress state information “2” is, as described later, registered to the second progress state information in the second memory 18 by the progress state management unit 15, and is also registered by the IC tag reader/writer 11 to the first progress information of the memory 32 of the IC tag 3.

The CPU (Central Processing Unit) 10 executes OS (Operating System) and programs stored in the first memory 17 beforehand, thereby performing varying arithmetic operations, and realizes functions of a comparing unit 13, a second updating unit 14, a progress state managing unit 15, a work processing unit 16, and a display control unit 23 as described later.

In this instance, programs for realizing functions of the comparing unit 13,. the second updating unit 14, the progress state management unit 15, the work processing unit 16, and the display control unit 23, are provided in the recorded forms in computer readable recorded forms, for example, flexible discs, CDs (CD-ROM, CD-R, CD-RW, etc.), a DVD (DVD-ROM, DVD-RAM, DVD-R, DVD+R, DVD-RW, DVD+RW, etc.), a magnetic disc, an optical disc, and magneto-optical disc. Then, the computer reads programs from the recording medium, and transfers it to the internal storage device and the external storage device to store therein. In addition, the programs can be stored in a storage device (recording medium) such as a magnetic disc, a optical disc, and a magneto-optical disc, etc. and can be provided to a portable terminal (computer) 4 through a communication paths.

When realizing the functions of the comparing unit 13, the second updating unit 14, the progress state management unit 15, the work processing unit 16, and the display control unit 23, programs stored in the internal storage device (the first memory 17, etc., in the present embodiment), are executed by a microprocessor (in the present embodiment, CPU 10) of the computer. At this time, programs recorded in the recoding medium can be read and executed by the computer.

Here, the “computer” is defined as a concept including hardware and an OS (Operating System), or hardware operating under control of an OS. Further, in cases where hardware is capable of operating by itself without the necessity of an OS, the hardware is equivalent to the “computer.” The hardware includes at least a micro processor such as a CPU, etc. and a means for reading computer programs from recording media. In the present embodiment, the portable terminal 4 functions as a computer.

The recording media of the present embodiment are computer-readable recording media such as flexible discs, CDs (CD-ROMs, CD-Rs, and CD-RWs, etc.), and DVDs (DVD-ROMs, DVD-RAMs, DVD-Rs, DVD+Rs, DVD-RWs, and DVD+RWs, etc.), magnetic disk, optical disk, magneto-optical disk, and various types of other computer-readable media, such as IC cards, ROM cartridges, magnetic tapes, punch cards, internal storage devices (memories such as RAMs and ROMs) of computers, external storage devices, and printed matter with any codes such as barcodes printed thereon, are also applicable.

The progress state management unit 15 manages the progress states of the inventory work of the operators. The progress state management unit 15 registers the progress state information of the inventory work to the second progress state information in the second memory 18, and as described above, registers the progress state information of the inventory work to the first progress state information of the memory 32 of the IC tag 3.

That is, for example, before an operator starts an inventory work to a shelf, the operator brings the IC tag reader/writer 11 close to the IC tag 3, and inputs that inventory work will be started (inventory work in progress) through the input key 20 of the portable terminal 4. Then, the progress state management unit 15 makes the IC tag reader/writer 11 register the progress state information “1” in association with the shelf number of the shelf to which the IC tag 3 is attached, to the first progress state information stored in the memory 32 of the IC tag 3.

In addition, when the operator completes the inventory work to the shelf, the operator inputs that the inventory work is completed (inventory completed) through input key 20 of the portable terminal 4. Then, the progress state management unit 15 registers the inventory state information “2” in association with the shelf number of the shelf to which the IC tag 3 is attached, to the second progress state information stored in the second memory 18.

Then, the operator brings the IC tag reader/writer 11 close to the IC tag 3, and for example, inputs that writing of the progress state information to the IC tag 3 will be performed. Hereby, to the first progress state information of the memory of the IC tag 3, the progress state information “2” is registered in association with the shelf number of the shelf number of the shelf to which the IC tag 3 is attached.

The comparing unit 13 compares the second progress state information stored in the second memory 18 with the first progress state information stored in the memory 32 of the IC tag 3, read by the IC tag reader/writer 11. The comparing unit 13 recognizes the shelf number to which “1” or “2” is registered only in the second progress state information or the shelf number to which the shelf number “1” or “2” is registered only in the first progress state information.

The second updating unit (updating unit) 14 updates the second memory 18 based on the comparing result of the comparing unit 13. More specifically, on the basis of the comparison result of the comparing unit 13, with respect to the shelves to which the progress state information “1” or “2”, like the first progress state information, the progress state information “1” or “2” is registered, thereby updating the second progress state information. That is, the second updating unit 14 registers the progress state information (“1”, “2”) registered only in the first progress state information to the second progress state information, thereby updating the second progress state information.

The work processing unit 16 performs processing relating to inventory work. In the inventory system 1, the work processing unit 16 performs various types of processing relating to inventory using partial master data 202 in the third memory 19 and data input from the barcode reader 12 and the input key 20.

The display control unit 23 performs control of the display 22. For example, the display control unit 23 controls to display the first progress state information and the second progress state information on the display unit 22. For example, the display control unit 23 makes the display unit 22 to show thereon the first progress state information, the second progress state information, varying data such as partial master data 202, etc., information input through the input key 20, instructions and messages from the programs or the like.

Then, the operator carries the portable terminal 4 as constructed above during a inventory work, and various types of operations are performed through the portable terminal 4.

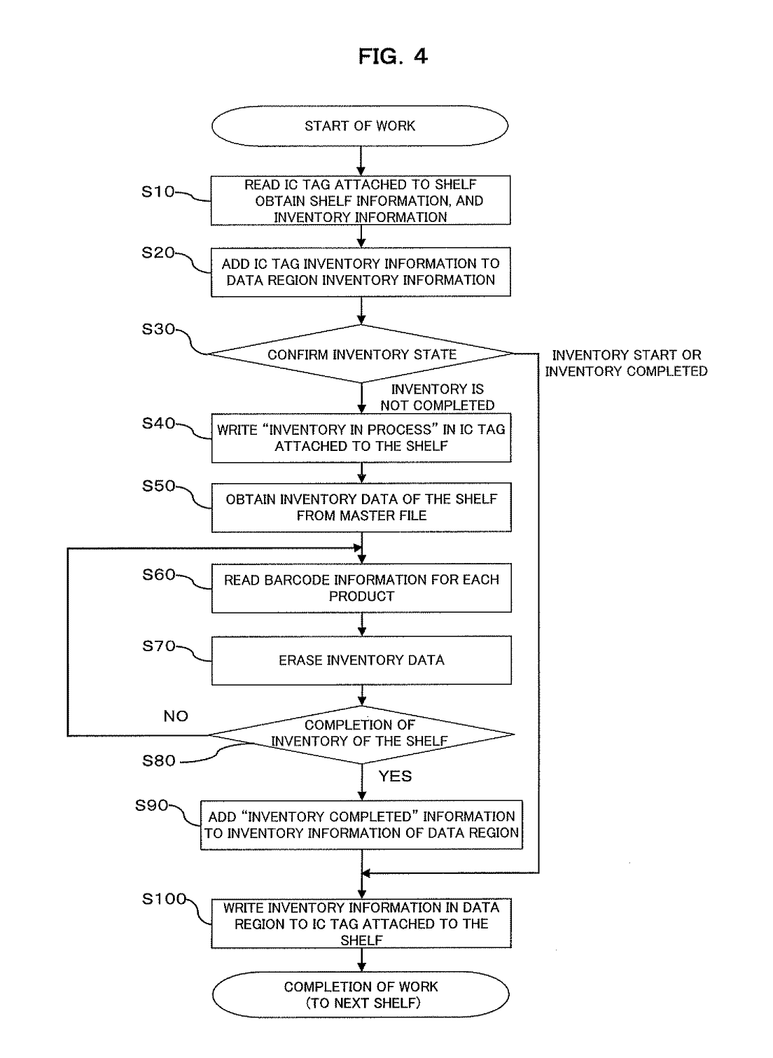

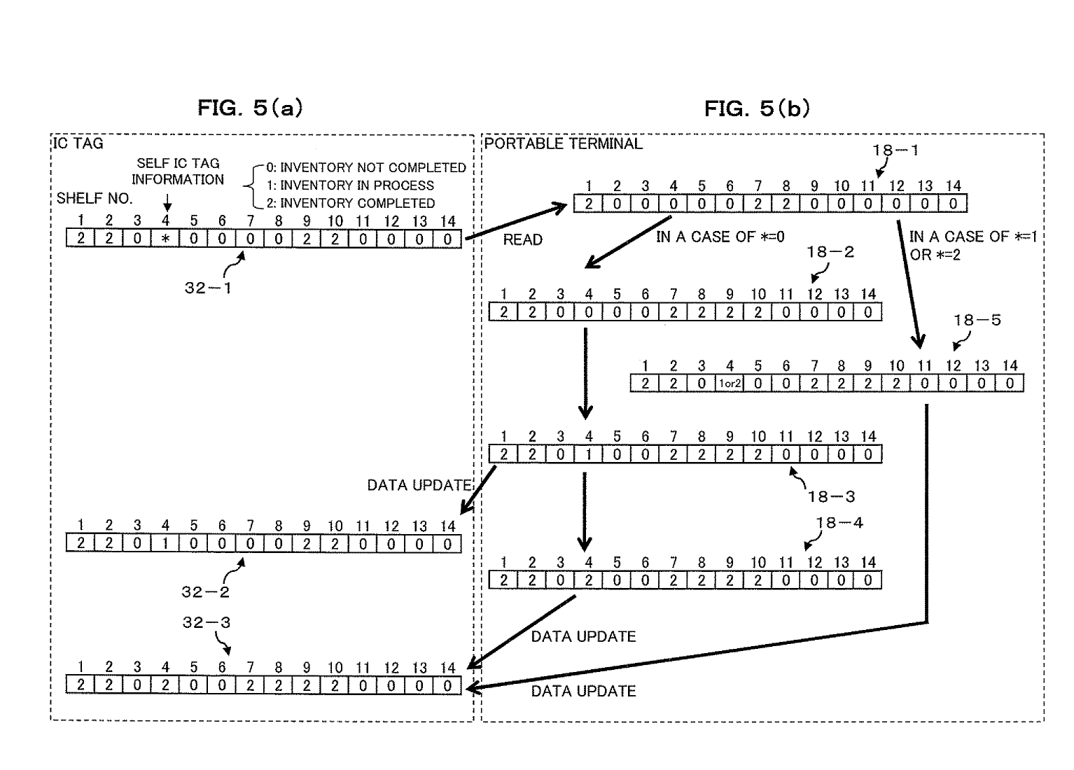

The operation procedure by an operator in the inventory system 1 as one preferred embodiment of the present invention with the above construction will be described following the flowchart (step S10 through S100) of FIG. 4 with reference to FIG. 5(a) and FIG. 5(b). In this instance, FIG. 5(a) and FIG. 5(b) are diagrams showing the first progress state information and the second progress state information in the inventory system 1 according to one preferred embodiment of the present invention. FIG. 5(a) is a diagram showing an example of the state of the first progress state information, and FIG. 5(b) is a diagram showing an example of the state of the second progress state information.

In this instance, in examples FIG. 5(a) and FIG. 5(b), an operator performs inventory work to the shelf T4 under the state where inventory work has already been completed to some of the shelves. Further, in the first progress state information 32-1 of FIG. 5(a), an asterisk (*) indicates, for convenience, that any of the values “0”, “1”, and “2” can be registered as the progress state information (self-IC tag information) corresponding to the shelf T4 (Shelf number, 4).

As to the shelf T4 to which inventory work will be performed hereinafter, the operator brings the portable terminal 4 close to the IC tag 3 attached to the shelf 4 to which inventory is to be performed. When reading of the first progress state information from the memory 32 of the IC tag 3 is instructed using the input key 20, the IC tag reader/writer 11 obtains the first progress state information [see the first progress state information 32-1 of FIG. 5(a); step S10]

In this instance, in the example of FIG. 5(a), the first progress state information 32-1 indicates inventory operations of shelves T1, T2, T9, T10 are completed. In the example of FIG. 5(b), the second progress state information 18-1 indicates inventory work of shelves T1, T7, and T8 are completed.

The comparing unit 13 compares the first progress state information 32-1 read by the IC tag reader/writer 11 with the second progress state information 18-1. The comparing unit 13 recognizes the shelf number to which the progress state information “1” or “2” is registered in only the first progress state information 32-1, and the progress state management unit 15 recognizes the number of the shelf. In this instance, in the examples of FIG. 5(a) and FIG. 5(b), in comparison of the first progress state information 32-1 and the second progress state information 18-1, the progress state information “2” is registered in shelf T2, T9, T10 only in the first progress state information 32-1.

On the basis of the comparison result by the comparing unit 13, the second updating unit 14, with respect to the shelf T2, T9, and T10 in which the progress state information “2” is registered only in the first progress state information, to the same shelf number 2, 9, and 10 of the second progress state information 18-1, the first progress state information of IC tag 3 is added (updated) to the second progresses state information [see the second progress state 18-2 of FIG. 5(b); step S20] by registering the progress state information “2” in the same manner as the first progress state information 32-1.

Then, in the updated second progress state information 18-2, the operator confirms the progress state information (self IC tag information) of the shelf T4 to which the IC tag 3 is attached (step S30). If the inventory state information “0” is set (see “inventory not completed” on step S30), the operator inputs that he/she performs inventory work to the shelf T4 through the input key 20 of the portable terminal 4. Hereby, the progress state management unit 15 registers the inventory state information “1”, indicating that inventory is in progress” in association with the shelf number 4 of the second progress state information (see the second work progress state information 18-3 of FIG. 5(b)).

In addition, the progress state management unit 15 writes the progress state information “1” indicating that inventory in progress, in association with the shelf number 4 of the first progress state information of the IC tag 3 attached to the shelf T4, with the IC tag reader/writer 11 [see the first state information 32-3 of FIG. 5(a); step S40].

The CPU 10 sends a request signal for partial master data 202 to the server 2 via the communication unit 24. When the server 2 sends partial master data 202 corresponding to the shelf T4 in response to the request, on the portable terminal 4, the communication unit 24 receives (obtains) the partial master data (inventory data) 202 (step S50) , and received data is stored in the third memory 19.

The operator reads barcode information of each product accommodated in the shelf T4 one by one, using the barcode reader 12 (step S60). The work processing unit 16 erases inventory data of partial master data 202 stored in the third memory 19 based on the read barcode information (step S70).

It is evaluated whether or not the above processing relating to inventory (step S60 through step S70) is performed to all the products of the shelf T4 (step S80). If the inventory work of the shelf T4 is not completed (see NO route of step S80), the procedure returns to step S60.

In addition, if the inventory work to the shelf T4 is completed (see YES route of step S80), the operator inputs that the inventory work to the shelf T4 is completed through the input key 20. Hereby, the progress state management unit 15 registers the shelf state information “2”, indicating that the inventory work is completed, in association with the shelf number 4 of the second progress state information (see the second work progress state information 18-4; step S90).

Then, the operator uses the IC tag reader/writer 11 of the portable terminal 4 to write the second progress state information of the second memory 18 into the first progress state information of the IC tag 3 attached to the shelf T4, thereby performs data updating [seethe first work progress state information 32-3 of FIG. 5(a); step S10] , and completes the inventory work to the shelf T4. The operator moves to a next shelf to perform inventory work.

Further, in the second progress state information 18-2 after updating, if the inventory state information “1” or “2” is set in the progress state information (self IC tag information) of the shelf T4 to which the IC tag 3 is attached (see route of “inventory start or inventory completed state” of the step S30), the procedure moves to the step S100.

In this instance, after the second progress state information is written in the first progress state information of the IC tag 3 which is attached to the shelf T4, it is preferred that the inventory state information “1” registered in association with the shelf number 4 of the second progress state information is treated as the inventory state information “2”.

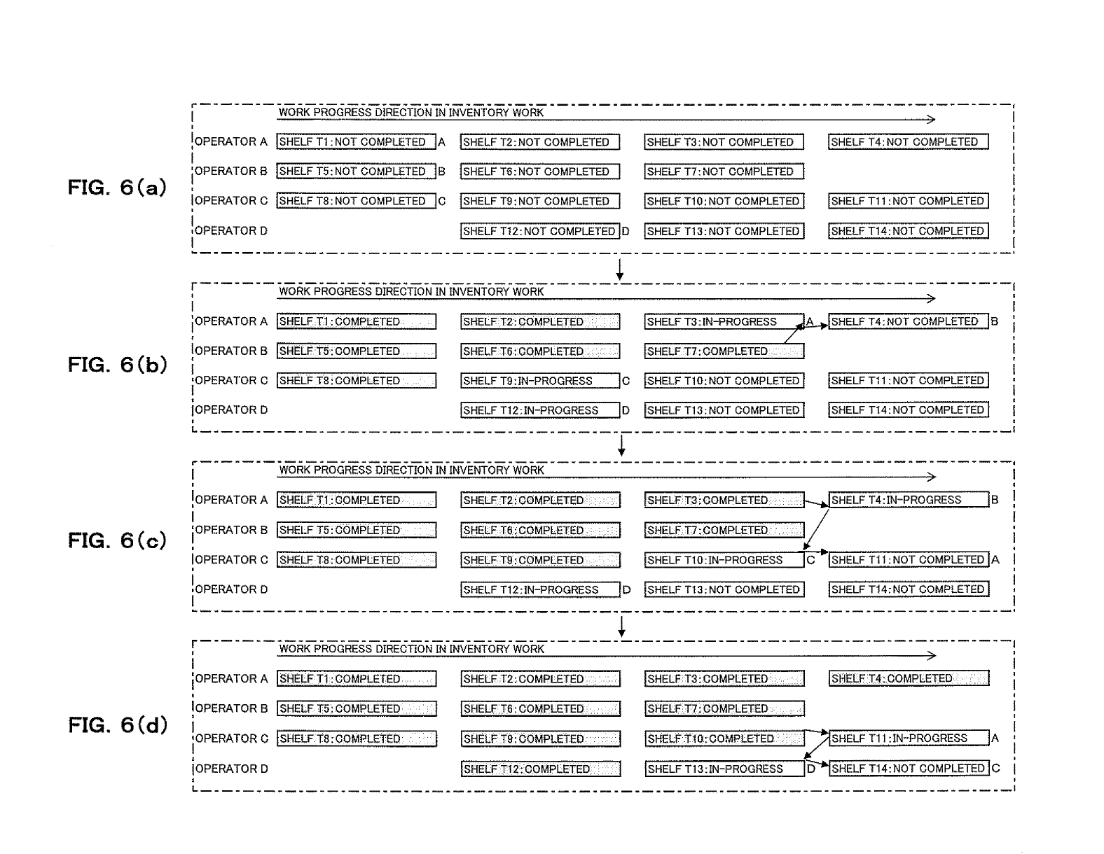

FIG. 6(a), FIG. 6(b), FIG. 6(c) and FIG. 6(d) are diagrams schematically showing the progress state of inventory work using the inventory system 1 according to one preferred embodiment of the present invention. The work is shown according to the time progress in the order of FIG. 6(a), FIG. 6(b), FIG. 6(c), and FIG. 6(d).

In the examples shown in FIG. 6(a), FIG. 6(b), FIG. 6(c), and FIG. 6(d), four operators A, B, C, and D perform an inventory work to 14 shelves, T1 through T14. Further, work is shared by the four operators: the operator A performs inventory work to the shelves T1, T2, T3, and T4; the operator B performs inventory work to the shelves T5, T6, and T7; the operator C performs inventory work to the shelves T8, T9, T10, and T11; and the operator D performs inventory work to the shelves T12, T13, and T14. Further, each operator proceeds inventory work from the left side shelf to the right side shelf one by one.

In this instance, in FIG. 6(a), FIG. 6(b) , FIG. 6(c), and FIG. 6(d), “not completed” indicates the state where inventory work is not performed; “in progress” indicates the state where inventory work is being now performed; “completed” indicates the state where inventory work is completed.

In the state shown in FIG. 6(a), inventory work is not performed to any of the shelves. From this state, each operator carries a portable terminal 4 to perform inventory work to the shelves assigned to each operator, starting from the left shelf one by one.

In the state shown in FIG. 6(b), the worker B finishes inventory work to the shelves assigned to himself/herself, and thus, the operator B moves to the shelf T3, which is assigned to the operator A, and uses the portable terminal 4 to read the first progress state information of the IC tag 3 attached to the shelf T3.

At this moment, the first progress state information of the IC tag 3 of the shelf T3 registers that inventory work to the shelf 5 through the shelf 7 is completed based on the second progress state information stored in the portable terminal 4 of operator B.

On the basis of the first progress state information having been read, the operator B can recognize that inventory work to the shelf T1 and T2 is completed, and that the operator A is now performing an inventory work to the shelf T3. The operator B moves to the next shelf T4, which is assigned to the operator A, and uses the portable terminal 4 to read the first progress state information of the IC tag 3 which is attached to the shelf T4, thereby confirming that inventory work to the shelf T4 is not yet performed, and begins the inventory work to the shelf T4.

On the other hand, in the state shown in FIG. 6(c), the operator A, who has finished an inventory work to the shelf T3, reads the IC tag 3 attached to the shelf T4 with the portable terminal 4, and acknowledges that inventory work to the shelves T7 through T7 is completed based on the first progress state information.

Next, the operator A uses the portable terminal 4 to read the first progress state information of IC tag 3 attached to the shelf T10, thereby acknowledging that an inventory work to the shelves T8 and T9 is completed, that the inventory work to the shelf T10 is in progress by the operator C, and that inventory work to the shelf T11 is not performed. On the basis of such information, the operator A moves to the shelf T11, and starts inventory work of the shelf T11.

In the state shown in FIG. 6(d) , the operator C reads the first progress state information of the IC tag 3 of the shelf T11, thereby acknowledging that inventory work to the shelves T1 through T10 is completed and that inventory work to the shelf 11 is in progress. The operator C moves to the shelf T13 based on such information, and uses the portable terminal 4 to read the first progress state information of the IC tag 3 attached to the shelf T13.

Further, at that time, the first progress state information of the IC tag 3 of the shelf T13 registers that inventory work to the shelves T1 through T11 is completed based on the second progress state information stored in the portable terminal 4 of the operator C.

On the basis of this first progress state information having been read, it is acknowledged that inventory work to the shelves T1 through T13 is completed, and that the operator D is in inventory process to the shelf T13. The operator C moves to the shelf T14, and uses the portable terminal 4 to read the first progress state information of the IC tag 3 attached to the shelf 14, thereby acknowledging that the inventory is not performed to the shelf T14. The operator C begins then inventory work to shelf T14.

The operators A, B, and D read the first progress state information of the IC tag 3 of the shelf T14, thereby confirming inventory work to the shelf Ti through shelf T13 is completed.

In this instance, in the present inventory system 1, when the portable terminal 4 reads the first progress state information of IC tag 3 attached to a shelf, if the progress state information is not registered in the IC tag 3, the operator needs to read and confirm the first progress state information of an IC tag 3 of the shelf, other than the shelf which he/she has performed inventory work, by the portable terminal 4 itself.

In this manner, according to the inventory system 1 as one preferred embodiment of the present invention, an operator uses a portable terminal 4 to read the first progress state information stored in the memory 32 of the IC tag 3. As a result, the operator can acknowledge the progress state of inventory work in each shelf, so that the operator can promptly recognize a shelf to which inventory work is to be performed, and thus, efficient work can be performed.

Further, when an operator uses a portable terminal 4 to read the first progress state information from an IC tag 3, the comparing unit 13 compares the first progress state information with the second progress state information stored in the second memory 18 of the portable terminal 4. On the basis of the comparison result, the IC tag reader/writer 11 and the second updating unit update the first progress state information and the second progress state information, so that these first progress state information and the second progress state information are always updated. Hence, information of these first progress state information and the second progress state information can be always maintained in the new state, so that the reliability and the usefulness are improved.

Further, to a shelf to which an inventory work has been completed, another operator does not perform an inventory work once again. Thus, the efficiency of the inventory work and reliability of a inventory work can be improved.

Furthermore, when managing the progress state of an inventory work, expensive equipment such as a server computer, etc. is not needed, so that it is possible to reduce install cost of the system, and operational cost.

Moreover, since the server 2 creates partial master data 202 corresponding to each shelf under the instruction from the portable terminal 4, and sends the master data 202 to the portable terminal 4, an occurrence of duplicated inventory work can be prevented.

Further, the present invention should by no means be limited to the above-illustrated embodiment, and various changes or modifications may be suggested without departing from the gist of the invention.

For example, when the progress state information is stored in the memory 32 of the IC tag 3 by the IC tag reader/writer 11 of a portable terminal 4, the work starting time, work finishing time, and an operator identification code, etc., can be written in the memory 32 of the IC tag 3. As a result, it is possible to obtain additional information relating to work, such as measure work time for each shelf and work amount of each operator, etc. These obtained information can be utilized for operation planning for the next inventory work, so that a convenient-to-use feature is high.

In the above-described embodiment, an example in which the progress management of the present inventory work is described. However, the present invention should by no means be limited to this, and the progress state of work other than an inventory work can be managed.

Further, in the above-described embodiment, as the progress state information, three numeral numbers of “0”, “1”, and “2” are used to express “inventory not completed”, “inventory in progress”, and “inventory completed”. However, the invention should by no means be limited, and various numeral numbers, character letters, and symbols can be used. Further, various states other than “inventory not completed”, “inventory in progress”, and “inventory completed” can be expressed by the progress state information.

In this instance, when each embodiment of the present invention is disclosed, the present invention can be performed and produced by the ordinary skilled in the art.

### INDUSTRIAL APPLICABILITY

Other than an inventory work, the present invention is applicable to management of the progress state of various works performed by operators to multiple work subjects.

What is claimed:

1. A management system which manages the progress of work performed to a plurality of work subjects, which work is performed by one or more operators, said system comprising:
an electronic tag provided for each of the work subjects; and
a portable terminal device which can be carried by the operator, said portable terminal device being communicable with said electronic tag,
wherein said electronic tag includes: a first storage unit which can store first progress state information that is formed by registering work progress information indicating work progress performed to the plurality of work subjects in association with each work subject, and
wherein said portable terminal device includes:
a second storage unit which can store second progress state information that is formed by registering work progress information indicating work progress performed to the plurality of work subjects in association with each work subject;
a reading unit which can read the first progress state information stored in said first storage unit of said electronic tag;
a comparing unit which compares the second progress state information stored in said second storage unit (18) and the first progress state information read by said reading unit; and
an updating unit which updates the first progress state information and the second progress state information based on the comparison result obtained by the comparison unit.

2. A managing system as set forth in claim 1, wherein said updating unit includes:
a first updating unit which updates the first progress state information by registering the progress state information registered only in the second progress state information to the first progress state information; and
a second updating unit which updates the second progress state information by registering the progress state information registered only in the first updating state information to the second progress state information.

3. A managing system as set forth in claim 1, wherein said portable terminal device includes an input unit to which a work complete report, which indicates that the work to the work subject by the operator is completed, is input;
wherein said first updating unit updates the first progress state information of said first storage unit based on the work complete report input by said input unit,
wherein said second updating unit updates the second progress state information of said second storage unit based on the work complete report input by the input unit.

4. A managing system as set forth in claim 2,
wherein said portable terminal device includes an input unit to which a work complete report, which indicates that the work to the work subject by the operator is completed, is input;
wherein said first updating unit updates the first progress state information of said first storage unit based on the work complete report input by said input unit,
wherein said second updating unit updates the second progress state information of said second storage unit based on the work complete report input by the input unit.

5. A managing system as set forth in claim 1, wherein said portable terminal device includes a progress state registering unit which is capable of registering the progress state information indicating “work in-progress” to the first progress state information in said first storage unit to the work subject relating the electronic tag.

6. A managing system as set forth in claim 2, wherein said portable terminal device includes a progress state registering unit which is capable of registering the progress state information indicating “work in-progress” to the first progress state information in said first storage unit to the work subject relating the electronic tag.

7. A managing system as set forth in claim 3, wherein said portable terminal device includes a progress state registering unit which is capable of registering the progress state information indicating “work in-progress” to the first progress state information in said first storage unit to the work subject relating the electronic tag.

8. A managing system as set forth in claim 4, wherein said portable terminal device includes a progress state registering unit which is capable of registering the progress state information indicating “work in-progress” to the first progress state information in said first storage unit to the work subject relating the electronic tag.

9. A managing system as set forth in claim 1, wherein said portable terminal includes a work processing unit which performs processing relating to the work.

10. A managing system as set forth in claim 9, wherein said portable terminal includes a work information storage unit which can store information used in the work.

11. A portable terminal device, which can be carried by an operator who performs work to a plurality of work subjects, which portable terminal device is communicable with an electronic tags which are provided for the plurality of work subjects, and which has a first storage unit that can store the first progress state information formed by the progress state information indicating the progress state of work which is performed to the plurality of work subjects in association with each work subject,
wherein said portable terminal device includes:
a second storage unit which is capable of storing second progress state information formed by registering the progress state information indicating the progress state of the work performed to the plurality of work subject in association with each work subject;
a reading unit which is capable of reading the first progress state information stored in said first storage unit of said electric tag;
a comparing unit which compares the second progress state information stored in said second storage unit with the first progress state information read by said reading unit; and
an updating unit which updates the first progress state information and the second progress state information based on the comparison result by said comparison unit.

12. A portable terminal device as set forth in claim 11, wherein said updating unit includes:
a first updating unit which updates the first progress state information by registering the progress state information, which is registered only in the second progress state information, to the first progress state information; and
the second updating unit which updates the second progress state information by registering the progress state information registered only in the first progress states information to the second progress state information.

13. A portable terminal device as set forth in claim 11, comprising:
an input unit to which the work complete report is input which indicates that the work to the work subject is completed,
wherein the first update unit updates the first progress state information of said first storage unit based on the work complete report input by said input unit, and
wherein said second updating unit updates the second progress state information stored in said second storage unit based on the work completion report input by said input unit.

14. A portable terminal device as set forth in claim 12, comprising:
an input unit to which the work complete report is input which indicates that the work to the work subject is completed,
wherein the first update unit updates the first progress state information of said first storage unit based on the work complete report input by said input unit (20), and
wherein said second updating unit updates the second progress state information stored in said second storage unit based on the work completion report input by said input unit.

15. A portable terminal device as set forth in claim 11, comprising a progress state registering unit which is capable of registering the progress state information indicating “work in-progress” to the first progress state information in said first storage unit to the work subject relating the electronic tag.

16. A portable terminal device as set forth in claim 12, comprising a progress state registering unit which is capable of registering the progress state information indicating “work in-progress” to the first progress state information in said first storage unit to the work subject relating the electronic tag.

17. A portable terminal device as set forth in claim 13, comprising a progress state registering unit which is capable of registering the progress state information indicating “work in-progress” to the first progress state information in said first storage unit to the work subject relating the electronic tag.

18. A portable terminal device as set forth in claim 14, comprising a progress state registering unit which is capable of registering the progress state information indicating “work in-progress” to the first progress state information in said first storage unit to the work subject relating the electronic tag.

19. A portable terminal device as set forth in claim 11, further comprising a work processing unit which performs processing relating to the work.

20. A portable terminal device as set forth in claim 19, further comprising a work information storage unit which is capable of storing information used in the work.
